(19) United States
(12) Patent Application Publication
(10) Pub. No.: US 2026/0237587 A1
(43) Pub. Date: Aug. 13, 2026

(54) SOLID-STATE CIRCUIT BREAKER

(71) Applicant: Schneider Electric Industries SAS, Rueil Malmaison (FR)

(72) Inventors: Yang HU, Shanghai (CN); Zhigang Han, Shanghai (CN)

(21) Appl. No.: 19/535,356

(22) Filed: Feb. 10, 2026

(30) Foreign Application Priority Data
Feb. 12, 2025 (CN) 202510155083.X

(51) Int. Cl. H01H 89/00

(52) U.S. Cl. CPC H01H 89/00

(57) ABSTRACT

According to the present disclosure, a solid-state circuit breaker is disclosed, an operating component of a mechanical switch of the solid-state circuit breaker can move among a closed position, a first switching position, an electronic open position, a second switching position and a manual open position, which are arranged in sequence. The solid-state circuit breaker further includes a first, a second and a third micro switch. The first micro switch is in a first disengaged state in a condition where the operating component is between the closed position and the first switching position, and is in a first triggered state in a condition where the operating component is between the first switching position and the manual open position. The second micro switch is in a second disengaged state in a condition where the operating component is between the closed position and the second switching position, and is in a second triggered state in a condition where the operating component is between the second switching position and the manual open position. The third micro switch is in a third disengaged state in a condition where the mechanical switch is in a non-tripped state, and the third micro switch is in a third triggered state in a condition where the mechanical switch is in a tripped state. The above-mentioned solid-state circuit breaker can accurately obtain the state of the solid-state circuit breaker in real time.

### TECHNICAL FIELD

The present disclosure relates to a solid-state circuit breaker.

### BACKGROUND

A solid-state circuit breaker is used to control the opening and closing of an electrical circuit and has several advantages, and can be adapted to a variety of applications.

Generally speaking, a solid-state circuit breaker is formed by an electronic switch and a mechanical switch connected in series. Since the mechanical switch can be controlled both electrically and manually, it is desirable to know the state of the mechanical switch in real time to achieve protection of the circuit system and the solid-state circuit breaker itself.

There is still room for improvement in existing solid-state circuit breakers in terms of obtaining the state of the mechanical switch, etc.

### SUMMARY

In view of the above problems, according to the present disclosure, a solid-state circuit breaker is proposed, including an electronic switch and a mechanical switch connected in series, the mechanical switch includes an operating component movable between a closed position, an electronic open position and a manual open position arranged in sequence, the solid-state circuit breaker further includes micro switches, the micro switches include a first micro switch, a second micro switch and a third micro switch, the first micro switch is configured to be driven by the operating component to switch between a first disengaged state and a first triggered state, the second micro switch is configured to be driven by the operating component to switch between a second disengaged state and a second triggered state, the third micro switch is configured to be driven by the mechanical switch to switch between a third disengaged state and a third triggered state, a first switching position is provided between the closed position and the electronic open position, a second switching position is provided between the electronic open position and the manual open position, in a condition where the operating component is between the closed position and the first switching position, the first micro switch is in the first disengaged state, in a condition where the operating component is between the first switching position and the manual open position, the first micro switch is in the first triggered state; in a condition where the operating component is between the closed position and the second switching position, the second micro switch is in the second disengaged state, and in a condition where the operating component is between the second switching position and the manual open position, the second micro switch is in the second triggered state; in a condition where the mechanical switch is in a non-tripped state, the third micro switch is in the third disengaged state, and in a condition where the mechanical switch is in a tripped state, the third micro switch is in the third triggered state.

For the solid-state circuit breaker according to the present disclosure, by setting the first micro switch, the second micro switch and the third micro switch, the state of the solid-state circuit breaker can be obtained in real time and accurately.

The solid-state circuit breaker according to the present disclosure may have one or more of the following features alone or in combination.

According to an embodiment, preferably, in a condition where the operating component is in the closed position, the first micro switch is in the first disengaged state and the second micro switch is in the second disengaged state; in a condition where the operating component is in the electronic open position, the first micro switch is in the first triggered state and the second micro switch is in the second disengaged state; in a condition where the operating component is in the manual open position, the first micro switch is in the first triggered state and the second micro switch is in the second triggered state.

According to an embodiment, preferably, the solid-state circuit breaker further includes a control unit configured to acquire respective states of the micro switches, wherein in a condition where the first micro switch is in the first disengaged state, the second micro switch is in the second triggered state, and the third micro switch is in the third triggered state, the control unit determines that at least one of the micro switches is in a fault state; in a condition where the first micro switch is in the first triggered state, the second micro switch is in the second triggered state, and the third micro switch is in the third triggered state, the control unit determines that at least one of the micro switches is in a fault state; and in a condition where the first micro switch is in the first disengaged state, the second micro switch is in the second triggered state, and the third micro switch is in the third disengaged state, the control unit determines that at least one of the micro switches is in a fault state.

According to an embodiment, preferably, in a condition where the control unit detects that the first micro switch is in the first triggered state, the second micro switch is in the second disengaged state, and the third micro switch is in the third disengaged state, the control unit detects respective states of the micro switches after waiting for a first duration, and if the respective states of the micro switches do not change after waiting for the first duration, the control unit determines that the mechanical switch or at least one of the micro switches is in a fault state.

According to an embodiment, preferably, in a condition where the control unit detects that the first micro switch is in the first disengaged state, the second micro switch is in the second disengaged state, and the third micro switch is in the third triggered state, the control unit detects respective states of the micro switches after waiting for a second duration, and if the respective states of the micro switches do not change after waiting for the second duration, the control unit determines that the mechanical switch or at least one of the micro switches is in a fault state.

According to an embodiment, preferably, after the control unit determines that at least one of the micro switches is in a fault state, or the mechanical switch or at least one of the micro switches is in a fault state, the solid-state circuit breaker enters an electronic open state, and/or the solid-state circuit breaker sends a fault alert message.

According to an embodiment, preferably, the solid-state circuit breaker further includes a control unit, the control unit is configured to acquire respective states of the micro switches to determine a motion state of the solid-state circuit breaker, the motion state includes an opening state and a closing state, wherein when the first micro switch switches from the first disengaged state to the first triggered state, the control unit determines that the solid-state circuit breaker is in the opening state; when the second micro switch switches from the second triggered state to the second disengaged state, the control unit determines that the solid-state circuit breaker is in the closing state.

According to an embodiment, preferably, the operating component is fixedly provided with a driving portion, the driving portion includes a first cam portion and a second cam portion fixed relative to each other, the first cam portion is able to press or not press a reed of the first micro switch with a movement of the operating component, to drive the first micro switch to switch between the first triggered state and the first disengaged state; the second cam portion is able to press or not press a reed of the second micro switch with the movement of the operating component, to drive the second micro switch to switch between the second triggered state and the second disengaged state.

According to an embodiment, preferably, the solid-state circuit breaker is configured to open the electronic switch when the first micro switch switches from the first disengaged state to the first triggered state, and to allow a moving contact and a stationary contact of the mechanical switch to separate from each other after opening the electronic switch.

According to an embodiment, preferably, the solid-state circuit breaker is configured to detect whether an electrical circuit that the solid-state circuit breaker is connected in is subjected to a reverse voltage with the operating component in the manual open position, and if a reverse voltage is detected in the electrical circuit, to prevent a moving contact and a stationary contact of the mechanical switch from coming into contact with each other when the second micro switch is switched from the second triggered state to the second disengaged state, and if no reverse voltage is detected in the electrical circuit, to allow the moving contact and the stationary contact to come into contact with each other after the second micro switch is switched from the second triggered state to the second disengaged state.

### BRIEF DESCRIPTION OF DRAWINGS

In order to explain the technical solutions of the embodiments of the present disclosure more clearly, the drawings of the embodiments of the present disclosure will be briefly introduced below. The drawings are only used to illustrate some embodiments of the present disclosure, but do not limit all embodiments of the present disclosure thereto.

FIG. 1 is a schematic view of the appearance of an operating component of a solid-state circuit breaker according to the present disclosure.

FIG. 2 is a perspective view of a portion of the solid-state circuit breaker according to the present disclosure.

FIG. 3A illustrates a perspective view of a third micro switch and its nearby components when the solid-state circuit breaker according to the present disclosure is in the closed state, and FIG. 3B illustrates a perspective view of the third micro switch and its nearby components when the solid-state circuit breaker according to the present disclosure is in the electronic open state.

FIGS. 4A to 4D show cross-sectional views of the solid-state circuit breaker according to the present disclosure at different moments in a manual opening process.

FIGS. 5A to 5D show cross-sectional views of the solid-state circuit breaker according to the present disclosure at different moments in a manual closing process.

FIG. 6A is a schematic diagram of the state changes of components of the solid-state circuit breaker according to the present disclosure during the manual opening process and the manual closing process, and FIG. 6B is a schematic diagram of the state changes of components of the solid-state circuit breaker according to the present disclosure during the electronic opening process and the manual resetting process.

### LIST OF REFERENCE SIGNS

10 mechanical switch
2 operating component
25 driving portion
251 first cam portion
252 second cam portion
201 I-shaped pattern
202 arrow pattern
203 O-shaped pattern
207 dotted line
208 dotted line
3 stationary contact
4 moving contact
5 transmission assembly
51 driving rod
61 first micro switch
615 reed of first micro switch
616 button of first micro switch
62 second micro switch
625 reed of second micro switch
626 button of second micro switch
63 third micro switch
636 button of third micro switch

### DETAILED DESCRIPTION

In order to make the purpose, technical solutions and advantages of the present disclosure clearer, the technical solutions of the embodiments of the present disclosure will be clearly and thoroughly described below with reference to the accompanying drawings of specific embodiments of the present disclosure. The same reference numbers in the drawings represent the same parts. It should be noted that the described embodiments are some, not all, of the embodiments of the present disclosure. All other embodiments obtained by those of ordinary skill in the art based on the described embodiments of the present disclosure and without creative efforts fall within the scope of protection of the present disclosure.

Unless otherwise defined, technical or scientific terms used herein shall have their ordinary meaning as commonly understood by one of ordinary skill in the art to which this disclosure belongs. Terms “first”, “second” and similar words used in the description and claims of this patent application do not indicate any order, quantity or importance, but are only used to distinguish different components. Likewise, words such as “a” or “an” do not necessarily indicate a quantitative limitation. Words such as “including” or “comprising” mean that the elements or items present before the word include the elements or items listed after the word and their equivalents, without excluding other elements or items. Terms such as “connect to” or “connect with” are not limited to physical or mechanical connections, but may include electrical connections, whether direct or indirect. “Up”, “down”, “left”, “right”, etc., are only used to express relative positional relationships. When the absolute position of the described object changes, the relative positional relationship may also change accordingly.

The present disclosure is described in detail below by describing exemplary embodiments.

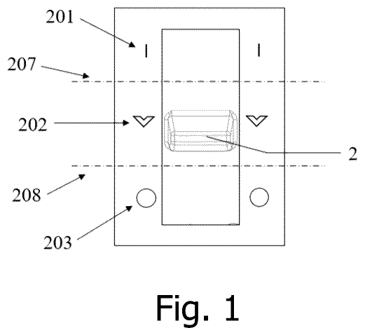

FIG. 1 shows a schematic view of the appearance of an operating component 2 of a solid-state circuit breaker according to an embodiment of the present disclosure. In FIG. 1, the operating component 2 has a protruding portion formed as a handle and passing through an opening in a housing of the solid-state circuit breaker, so that the operating component 2 can be accessed by, for example, operating personnel to be operated. The housing of the solid-state circuit breaker may be provided, in the vicinity of the opening, with patterns indicating the position of the operating component 2. According to the present disclosure, the operating component 2 can move between a closed position (corresponding to a condition where the protruding portion of the operating component 2 is located near an I-shaped pattern 201 in FIG. 1), an electronic open position (corresponding to a condition where the protruding portion of the operating component 2 is located near an arrow pattern 202 in FIG. 1) and a manual open position (corresponding to a condition where the protruding portion of the operating component 2 is located near an O-shaped pattern 203 in FIG. 1) arranged in sequence. When the operating component 2 stays at the closed position, the solid-state circuit breaker is in a closed state. When the operating component 2 stays at the electronic open position, the solid-state circuit breaker is in an electronic open state. When the operating component 2 stays at the manual open position, the solid-state circuit breaker is in a manual open state. It should be noted that according to the present disclosure, the specific shape of the operating component 2 is not limited to the shape shown in the drawings (for example, the portion of the operating component 2 that is subjected to external operation may be a structure other than a protrusion), as long as the operating component 2 can move between the closed position, the electronic open position and the manual open position arranged in sequence.

With further reference to FIG. 1, according to the present disclosure, a first switching position is provided between the closed position and the electronic open position of the operating component 2 (corresponding to a condition where the protruding portion of the operating component 2 is located near the dotted line 207 in FIG. 1), and a second switching position is provided between the electronic open position and the manual open position of the operating component 2 (corresponding to a condition where the protruding portion of the operating component 2 is located near the dotted line 208 in FIG. 1).

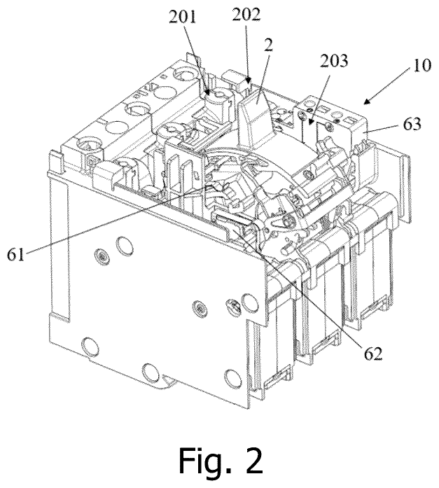

FIG. 2 is a perspective view of a portion of a solid-state circuit breaker according to an embodiment of the present disclosure. The solid-state circuit breaker according to the present disclosure includes an electronic switch and a mechanical switch 10 connected in series. The mechanical switch 10 includes the aforementioned operating component 2. The housing portion around the protruding portion of the operating component 2 covering other components of the mechanical switch 10 is not shown in FIG. 2, but respective positions of the aforementioned I-shaped pattern 201, arrow pattern 202 and O-shaped pattern 203 relative to the protruding portion of the operating component 2 are schematically shown. FIG. 2 also shows three micro switches. As shown in FIG. 2, the solid-state circuit breaker according to the present disclosure includes a first micro switch 61, a second micro switch 62 and a third micro switch 63.

According to the present disclosure, the first micro switch 61 is configured to be driven by the operating component 2 to switch between a first disengaged state and a first triggered state, and the second micro switch 62 is configured to be driven by the operating component 2 to switch between a second disengaged state and a second triggered state, and the third micro switch 63 is configured to be driven by the mechanical switch 10 to switch between a third disengaged state and a third triggered state.

Specifically, regarding the first micro switch 61, in a condition where the operating component 2 is between the closed position and the first switching position, the first micro switch 61 is in the first disengaged state, and in a condition where the operating component 2 is between the first switching position and the manual open position, the first micro switch 61 is in the first triggered state. In other words, when the operating component 2 moves past the first switching position, it drives the switching of the first micro switch 61 between the first disengaged state and the first triggered state. In addition, in a condition where the operating component 2 is in the closed position, the first micro switch 61 is in the first disengaged state, and in a condition where the operating component 2 is in the electronic open position, the first micro switch 61 is in the first triggered state., in a condition where the operating component 2 is in the manual open position, the first micro switch 61 is in the first triggered state.

Regarding the second micro switch 62, in a condition where the operating component 2 is between the closed position and the second switching position, the second micro switch 62 is in the second disengaged state, and in a condition where the operating component 2 is between the second switching position and the manual open position, the second micro switch 62 is in the second triggered state. In other words, when the operating component 2 moves past the second switching position, it drives the switching of the second micro switch 62 between the second disengaged state and the second triggered state. In addition, in a condition where the operating component 2 is in the closed position, the second micro switch 62 is in the second disengaged state, and in a condition where the operating component 2 is in the electronic open position, the second micro switch 62 is in the second disengaged state., in a condition where the operating component 2 is in the manual open position, the second micro switch 62 is in the second triggered state.

For the third micro switch 63, in a condition where the mechanical switch 10 is in a non-tripped state, the third micro switch 63 is in the third disengaged state, and in a condition where the mechanical switch 10 is in a tripped state, the third micro switch 63 is in the third triggered state. In other words, when the mechanical switch 10 transitions between the non-tripped state and the tripped state, it drives the third micro switch 63 to switch between the third disengaged state and the third triggered state.

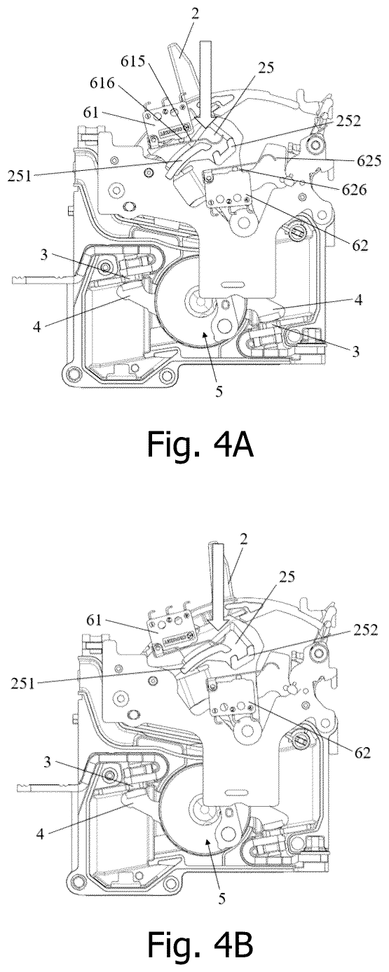

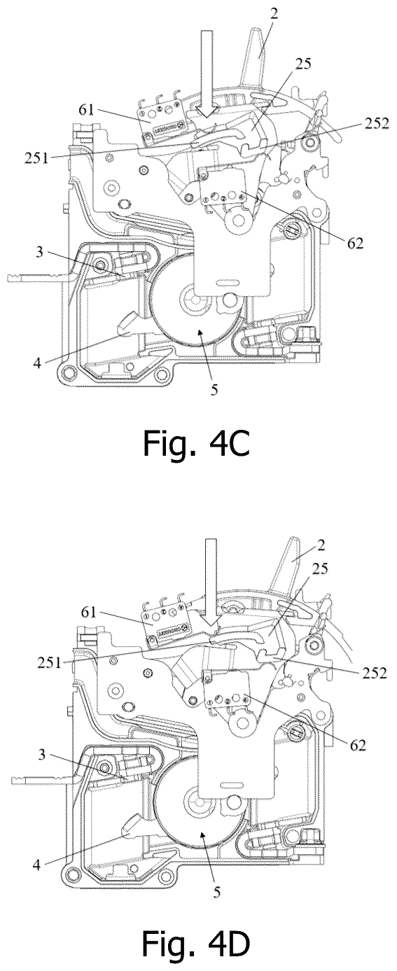

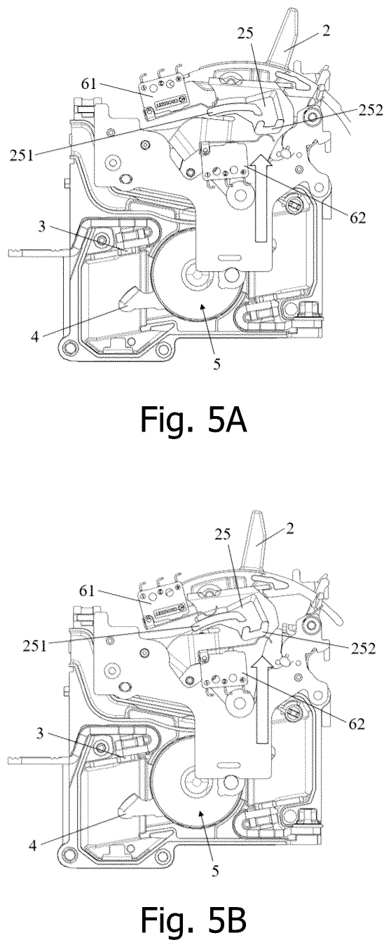

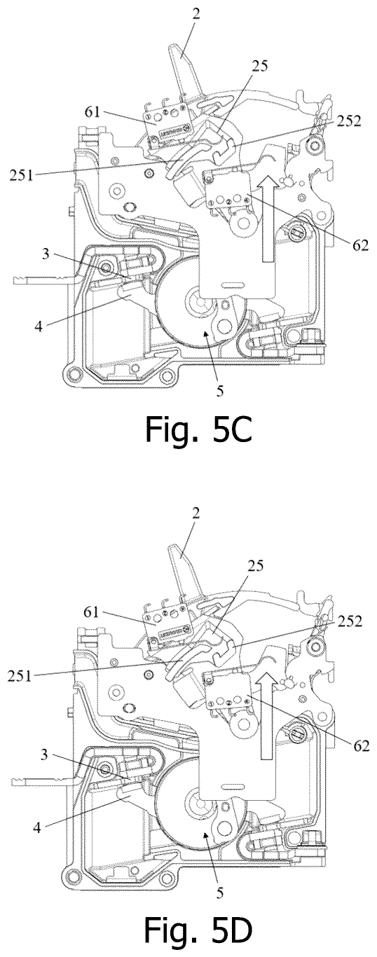

In particular, according to an embodiment of the present disclosure, the mechanical switch 10 further includes a transmission assembly 5. The operating component 2 is connected to the transmission assembly 5, and the transmission assembly 5 is connected to a moving contact 3 of the mechanical switch 10. Thereby, the operating component 2 can drive the moving contact 3 via the transmission assembly 5 to bring the moving contact 3 into contact with or separate from a stationary contact 4 (see also FIGS. 4A to 4D and FIGS. 5A to 5D). In all of the above situations, the mechanical switch 10 is in a non-tripped state. In addition, the mechanical switch 10 also includes a tripping assembly (not shown in the drawings). The tripping assembly is connected to the transmission assembly 5 so that in an event of a fault in the solid-state circuit breaker (e.g. an excessive current), the tripping assembly trips, thereby separating the moving contact 3 from the stationary contact 4 via the transmission assembly 5. In such a case, the mechanical switch 10 is in the tripped state, and accordingly, the operating component 2 is driven to the electronic open position and stays at the electronic open position.

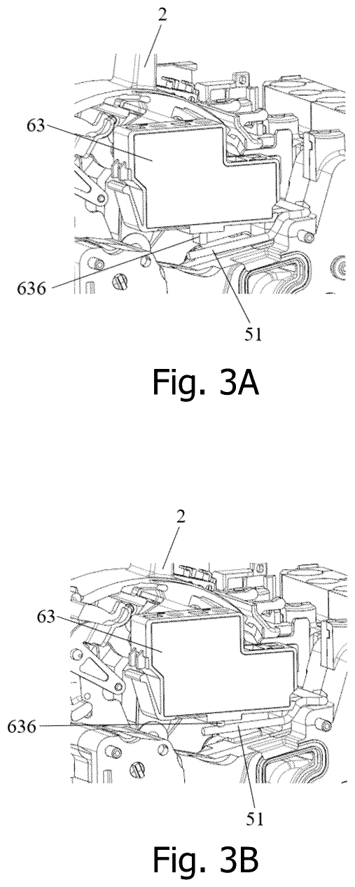

FIG. 3A illustrates a perspective view of the third micro switch 63 and its nearby components when the solid-state circuit breaker is in the closed state, and FIG. 3B illustrates a perspective view of the third micro switch 63 and its nearby components when the solid-state circuit breaker is in the electronic open state, according to an embodiment of the present disclosure. According to an embodiment of the present disclosure, a free end of a driving rod 51 rotatably attached to the transmission assembly 5 is disposed near a button 636 of the third micro switch 63. In a condition where the mechanical switch 10 is in the non-tripped state, the free end of the driving rod 51 is spaced away from the button 636 (FIG. 3A), and at this time, the third micro switch 63 is in the third disengaged state. In a condition where the mechanical switch 10 is in the tripped state, the free end of the driving rod 51 presses the button 636 (FIG. 3B), and at this time, the third micro switch 63 is in the third triggered state. It should be noted that the corresponding hardware states of the third micro switch 63 in the third disengaged state and in the third triggered state shown in FIGS. 3A and 3B are only examples. According to the present disclosure, the third disengaged state and the third triggered state only serve as two distinguishable states of the third micro switch 63, the switching of the two states is driven by the mechanical switch 10, and the two states correspond respectively to the conditions where the mechanical switch 10 is in the non-tripped state and the tripped state.

FIGS. 4A to 4D show cross-sectional views of the solid-state circuit breaker according to the present disclosure at different moments during the manual opening process, each showing the operating component 2, the moving contact 3, the stationary contact 4 and a part of the transmission assembly 5. FIGS. 4A to 4D also show the first micro switch 61 and the second micro switch 62, respectively. According to an embodiment of the present disclosure, the first micro switch 61 includes a body, a button 616 and a reed 615, and the reed 615 can be driven by an external force to press the button 616. In a condition where the reed 615 does not press the button 616, the first micro switch 61 is in the first disengaged state, and in a condition where the reed 615 presses the button 616, the first micro switch 61 is in the first triggered state. According to an embodiment of the present disclosure, the second micro switch 62 includes a body, a button 626 and a reed 625, and the reed 625 can be driven by an external force to press the button 626. In a condition where the reed 625 does not press the button 626, the second micro switch 62 is in the second disengaged state, and in a condition where the reed 625 presses the button 626, the second micro switch 62 is in the second triggered state.

As shown in FIGS. 4A to 4D, the operating component 2 is also fixedly provided with a driving portion 25, and the driving portion 25 includes a first cam portion 251 and a second cam portion 252 that are fixed relative to each other. For example, the first cam portion 251 and the second cam portion 252 are respectively fixed to a main body of the driving portion 25, or are integrally formed with the main body of the driving portion 25. The first cam portion 251 can press or not press the reed 615 of the first micro switch 61 with the movement of the operating component 2, so as to drive the first micro switch 61 to switch between the first triggered state and the first disengaged state. The second cam portion 252 can press or not press the reed 625 of the second micro switch 62 with the movement of the operating component 2, so as to drive the second micro switch 62 to switch between the second triggered state and the second disengaged state.

It should be noted that the corresponding hardware states of the first micro switch 61 in the first disengaged state and the first triggered state, and the corresponding hardware states of the second micro switch 62 in the second disengaged state and the second triggered state shown in the drawings are only examples. In addition, the way of driving in which the operating component 2 drives the first micro switch 61 and the second micro switch 62 is also only an example. According to the present disclosure, the first disengaged state and the first triggered state only serve as two distinguishable states of the first micro switch 61, the switching of the two states is driven by the movement of the operating component 2 passing the first switching position. Likewise, according to the present disclosure, the second disengaged state and the second triggered state only serve as two distinguishable states of the second micro switch 62, the switching of the two states is driven by the movement of the operating component 2 passing the second switching position.

Next, with reference to FIGS. 4A to 4D, the state changes of corresponding components during the manual opening process of the solid-state circuit breaker according to the present disclosure are described. In FIGS. 4A to 4D, hollow arrows are used to emphasize the state changes of the first micro switch 61 during this process.

In FIG. 4A, the operating component 2 is in the closed position. At this time, the moving contact 3 contacts the stationary contact 4. In another aspect, for the first micro switch 61, its reed 615 does not press its button 616, and the first micro switch 61 is in the first disengaged state. For the second micro switch 62, its reed 625 does not press its button 626, and the second micro switch 62 is in the second disengaged state.

In FIG. 4B, the operating component 2 moves to the first switching position. At this time, the moving contact 3 contacts the stationary contact 4. In another aspect, for the first micro switch 61, its reed 615 is driven by the first cam portion 251 of the driving portion 25 of the operating component 2 to press the button 616, and the first micro switch 61 is switched to the first triggered state. For the second micro switch 62, its reed 625 does not press its button 626, and the second micro switch 62 is in the second disengaged state.

In FIG. 4C, the operating component 2 continues to move towards the manual open position. At the moment shown in FIG. 4C, the operating component 2 has driven the transmission assembly 5 so that the moving contact 3 is separated from the stationary contact 4. In another aspect, for the first micro switch 61, its reed 615 keeps pressing its button 616 driven by the first cam portion 251, and the first micro switch 61 is in the first triggered state. For the second micro switch 62, its reed 625 is going to be driven by the second cam portion 252 of the driving portion 25 of the operating component 2 to press the button 626, and the second micro switch 62 is going to be switched from the second disengaged state to the second triggered state.

In FIG. 4D, the operating component 2 has moved to the manual open position. At this time, the moving contact 3 and the stationary contact 4 are separated. In another aspect, for the first micro switch 61, its reed 615 keeps pressing its button 616 driven by the first cam portion 251, and the first micro switch 61 is in the first triggered state. For the second micro switch 62, its reed 625 is driven by the second cam portion 252 to press the button 626, and the second micro switch 62 is in the second triggered state.

As can be seen in FIGS. 4A to 4D, according to an embodiment of the present disclosure, the solid-state circuit breaker is configured to allow the moving contact 3 and the stationary contact 4 to separate from each other after the first micro switch 61 is switched from the first disengaged state to the first triggered state. Thus, according to an embodiment of the present disclosure, the solid-state circuit breaker is configured to open the electronic switch when the first micro switch 61 is switched from the first disengaged state to the first triggered state, and to allow the moving contact 3 and the stationary contact 4 to separate from each other after opening the electronic switch. This ensures that when the moving contact 3 and the stationary contact 4 are separated, they are in a state carrying no current and do not generate an arc.

Next, with reference to FIGS. 5A to 5D, the state changes of corresponding components during the manual closing process of the solid-state circuit breaker according to the present disclosure are described. In FIGS. 5A to 5D, hollow arrows are used to emphasize the state change of the second micro switch 62 during this process.

In FIG. 5A, the solid-state circuit breaker is in the manual open state, and the respective states of the components are the same as those shown in FIG. 4D.

In FIG. 5B, the operating component 2 moves to the second switching position. At this time, the moving contact 3 and the stationary contact 4 are separated. In another aspect, for the second micro switch 62, its reed 625 no longer presses its button 626, and the second micro switch 62 switches from the second triggered state to the second disengaged state. For the first micro switch 61, its reed 615 keeps pressing its button 616 driven by the first cam portion 251, and the first micro switch 61 is in the first triggered state.

In FIG. 5C, the operating component 2 continues to move towards the closed position. At the moment shown in FIG. 5C, the operating component 2 has driven the transmission assembly 5 so that the moving contact 3 contacts the stationary contact 4. In another aspect, for the second micro switch 62, its reed 625 does not press its button 626, and the second micro switch 62 is in the second disengaged state. For the first micro switch 61, its reed 615 no longer presses its button 616, and the first micro switch 61 is in the first disengaged state.

In FIG. 5D, the operating component 2 has moved to the closed position. At this time, the moving contact 3 contacts the stationary contact 4. In another aspect, for the second micro switch 62, its reed 625 does not press its button 626, and the second micro switch 62 is in the second disengaged state. For the first micro switch 61, its reed 616 does not press its button 616, and the first micro switch 61 is in the first disengaged state.

As can be seen in FIGS. 5A to 5D, according to an embodiment of the present disclosure, the solid-state circuit breaker may be configured to allow the moving contact 3 to contact the stationary contact 4 after the second micro switch 62 is switched from the second triggered state to the second disengaged state. According to another embodiment of the present disclosure, the solid-state circuit breaker is configured to, in a condition where the operating component 2 is in the manual open position, detect whether the electrical circuit that the solid-state circuit breaker is connected in is subjected to a reverse voltage, that is, detect whether the electrical circuit that the solid-state circuit breaker is placed in is connected in reverse, and, if a reverse voltage of the electrical circuit is detected, the moving contact 3 and the stationary contact 4 are prevented from contacting each other when the second micro switch 62 switches from the second triggered state to the second disengaged state, that is, the mechanical switch 10 is driven to trip. In another aspect, if no reverse voltage of the electrical circuit is detected, the moving contact 3 and the stationary contact 4 are allowed to contact each other after the second micro switch 62 switches from the second triggered state to the second disengaged state, that is, the mechanical switch 10 does not trip during the manual closing process. Therefore, the contacts are prevented from closing under a reverse voltage condition, thereby ensuring the safety of the solid-state circuit breaker.

According to an embodiment of the present disclosure, the solid-state circuit breaker includes a control unit (not shown in the drawings). The control unit is configured to acquire respective states of the first micro switch 61, the second micro switch 62 and the third micro switch 63 to determine the working state of the solid-state circuit breaker.

According to an embodiment of the present disclosure, the control unit may determine a motion state of the solid-state circuit breaker, the motion state including an opening state and a closing state. Specifically, when the first micro switch 61 switches from the first disengaged state to the first triggered state, the control unit determines that the solid-state circuit breaker is in the opening state, and when the second micro switch 62 switches from the second triggered state to the second disengaged state, the control unit determines that the solid-state circuit breaker is in the closing state.

Further, according to an embodiment of the present disclosure, the control unit of the solid-state circuit breaker can, by obtaining respective states of the first micro switch 61, the second micro switch 62 and the third micro switch 63, determine whether there is any micro switch that is in a fault state among the micro switches. Thus, the solid-state circuit breaker according to the present disclosure may also has self-diagnostic capabilities.

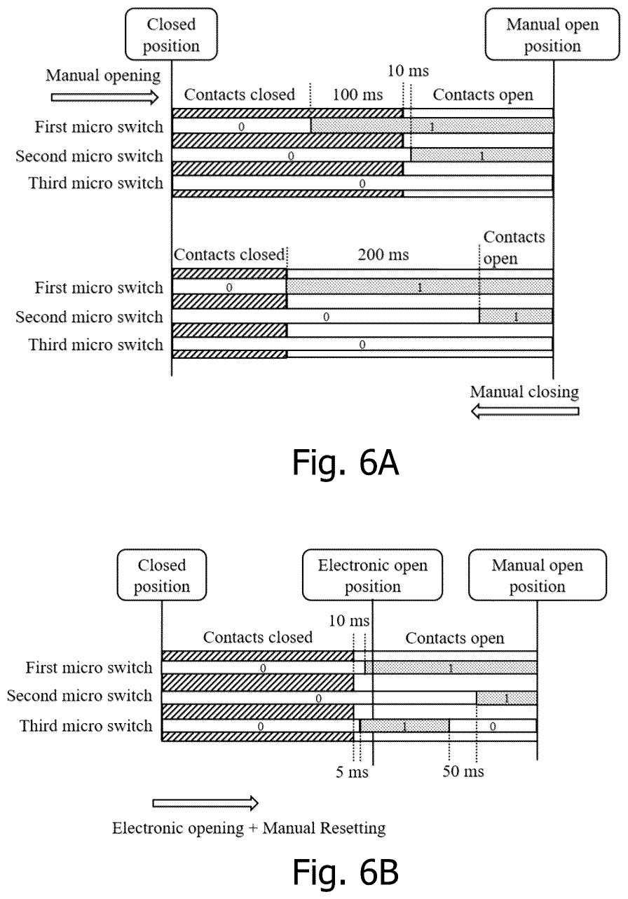

For convenience of explanation, FIG. 6A shows a schematic diagram of the state changes of related components when the solid-state circuit breaker undergoes the manual opening process and the manual closing process, and FIG. 6B shows a schematic diagram of the state changes of related components when the solid-state circuit breaker undergoes the electronic opening process and the manual resetting process. In FIGS. 6A and 6B, the abscissa corresponds to the position of the operating component 2, that is, the leftmost end is the closed position of the operating component 2, and the rightmost end is the manual open position of the operating component 2. In FIG. 6A, the upper half shows the respective states of the components during the manual opening process, and the lower half shows the respective states of the components during the manual closing process. For both the upper and lower halves of FIG. 6A, the contact state of the moving contact 3 and the stationary contact 4 is used as the background pattern. The condition of the moving contact 3 and the stationary contact 4 contacting each other (contacts closed) corresponds to a line hatched background., and the condition of the moving contact 3 and the stationary contact 4 separated (contacts open) corresponds to a white background. On top of the background pattern, the respective states of the first micro switch 61, the second micro switch 62, and the third micro switch 63 are displayed in thinner strips. Respective disengaged states of the micro switches are each displayed as a white strip, and respective triggered states of the micro switches are each displayed as a strip with a dot hatched pattern. For convenience of subsequent description, respective disengaged states of the micro switches are also each marked with “0” in the figure, and respective triggered states of the micro switches are also each marked with “1” in the figure. In addition, FIG. 6B is depicted in the same way as FIG. 6A.

It should be noted that the state change timings of the components shown in FIGS. 6A and 6B correspond to the configuration of components shown in FIG. 4A to 4D and 5A to 5D. Referring to FIG. 6B, it shows the state changes of the components during the electronic opening process and the manual resetting process of the solid-state circuit breaker (the manual resetting process is the process of moving the operating component 2 from the electronic open position to the manual open position by external operation). It should be noted that because the electronic opening of the solid-state circuit breaker is not driven by the operating component 2 (for example, the electronic opening is driven by the tripping assembly), the relationship between the moment when the moving contact 3 separates from the stationary contact 4 and the moment when the state of the first micro switch 61 is switched can be different from that in the case of manual opening. In addition, in the case of electronic opening, because the mechanical switch 10 trips, the solid-state circuit breaker is configured to switch the third micro switch 63 from the third disengaged state to the third triggered state when the mechanical switch 10 trips, and to switch the third micro switch 63 from the third triggered state to the third disengaged state when the mechanical switch 10 returns from the tripped state to the non-tripped state(this happens during the process of moving the operating component 2 from the electronic open position to the manual open position by external operation).

As can be seen in FIGS. 6A and 6B, for stable states of the solid-state circuit breaker (i.e., the closed state, the electronic open state and the manual open state), the three micro switches themselves each have a set state. For example, as mentioned above, with “0” representing the disengaged state of each micro switch, and “1” representing the triggered state of each micro switch, according to a sequence of “the first micro switch 61, the second micro switch 62, the third micro switch 63”, a micro switch state combination corresponding to the closed state is “000”, a micro switch state combination corresponding to the electronic open state is “101”, and a micro switch state combination corresponding to the manual open state is “110”.

In addition, it can be seen in FIGS. 6A and 6B that micro switch state combination of “011”, “111” and “010” do not occur at any time during operation of the solid-state circuit breaker. Therefore, if the control unit obtains one of these three micro switch state combinations, it can be determined that at least one micro switch is in a fault state. In other words, the control unit determines that at least one of the micro switches is in a fault state for the following three conditions: the first micro switch 61 is in a first disengaged state, the second micro switch 62 is in a second triggered state, and the third micro switch 63 is in a third triggered state; the first micro switch 61 is in a first triggered state, the second micro switch 62 is in a second triggered state, and the third micro switch 63 is in a third triggered state; the first micro switch 61 is in the first disengaged state, the second micro switch 62 is in the second triggered state, and the third micro switch 63 is in the third disengaged state.

According to an embodiment of the present disclosure, after the control unit determines that at least one of the micro switches is in a fault state, the solid-state circuit breaker enters the electronic open state. Additionally or alternatively, the solid-state circuit breaker sends a fault alert message to indicate that at least one of the micro switches is in a fault state.

In addition, as can be seen in FIGS. 6A and 6B, micro switch state combinations “100” (see FIG. 6A) and “001” (see FIG. 6B) may occur relatively briefly while the solid-state circuit breaker is operating. If the components of the solid-state circuit breaker are working properly, both micro switch state combinations will transfer to one of the closing state, the electronic open state and the manual open state after a specific duration (i.e., the micro switch state combination will transfer to one of “000”, “101”, and “110”). If, after a certain amount of time, the two micro switch state combinations do not change, it can be determined that the mechanical switch, or at least one of the micro switches, is in a fault state.

In other words, according to an embodiment of the present disclosure, in a condition where the control unit detects that the first micro switch 61 is in the first triggered state, the second micro switch 62 is in the second disengaged state, and the third micro switch 63 is in the third disengaged state, the control unit detects respective states of the micro switches after waiting for a first duration, and if the respective states of the micro switches do not change after waiting for the first duration, the control unit determines that the mechanical switch or at least one of the micro switches is in a fault state. For example, for a configuration of the solid-state circuit breaker corresponding to FIGS. 6A and 6B, the first duration may be a value greater than 200 ms.

Similarly, according to an embodiment of the present disclosure, in a condition where the control unit detects that the first micro switch 61 is in the first disengaged state, the second micro switch 62 is in the second disengaged state, and the third micro switch 63 is in the third triggered state, the control unit detects respective states of the micro switches after waiting for a second duration, and if the respective states of the micro switches do not change after waiting for the second duration, the control unit determines that the mechanical switch or at least one of the switches is in a fault state. For example, for the configuration of the solid-state circuit breaker corresponding to FIGS. 6A and 6B, the second duration may be a value greater than 5 ms.

According to an embodiment of the present disclosure, after the control unit determines that the mechanical switch or at least one of the micro switches is in a fault state, the solid-state circuit breaker enters the electronic open state. Additionally or alternatively, the solid-state circuit breaker sends a fault alert message to indicate that the mechanical switch or at least one of the micro switches is in a fault state.

The exemplary implementations of the solid-state circuit breaker proposed by the present disclosure have been described in detail above with reference to preferred embodiments. However, those skilled in the art can understand that various changes and modifications can be made to the above specific embodiments without departing from the concept of the present disclosure, and various technical features and structures proposed by the present disclosure can be variously combined without departing from the protection scope of the present disclosure.

1. A solid-state circuit breaker comprising an electronic switch and a mechanical switch connected in series, the mechanical switch comprising an operating component movable between a closed position, an electronic open position and a manual open position arranged in sequence,
wherein the solid-state circuit breaker further comprises micro switches, the micro switches comprises a first micro switch, a second micro switch a third micro switch, the first micro switch is configured to be driven by the operating component to switch between a first disengaged state and a first triggered state, the second micro switch is configured to be driven by the operating component to switch between a second disengaged state and a second triggered state, and the third micro switch is configured to be driven by the mechanical switch to switch between a third disengaged state and a third triggered state, wherein,
a first switching position is provided between the closed position and the electronic open position, a second switching position is provided between the electronic open position and the manual open position,
in a condition where the operating component is between the closed position and the first switching position, the first micro switch is in the first disengaged state, and in a condition where the operating component is between the first switching position and the manual open position, the first micro switch is in the first triggered state;
in a condition where the operating component is between the closed position and the second switching position, the second micro switch is in the second disengaged state, and in a condition where the operating component is between the second switching position and the manual open position, the second micro switch is in the second triggered state;
in a condition where the mechanical switch is in a non-tripped state, the third micro switch is in the third disengaged state, and in a condition where the mechanical switch is in a tripped state, the third micro switch is in the third triggered state.

2. The solid-state circuit breaker according to claim 1, wherein
in a condition where the operating component is in the closed position, the first micro switch is in the first disengaged state and the second micro switch is in the second disengaged state;
in a condition where the operating component is in the electronic open position, the first micro switch is in the first triggered state and the second micro switch is in the second disengaged state;
in a condition where the operating component is in the manual open position, the first micro switch is in the first triggered state and the second micro switch is in the second triggered state.

3. The solid-state circuit breaker according to claim 2, further comprising a control unit configured to acquire respective states of the micro switches, wherein
in a condition where the first micro switch is in the first disengaged state, the second micro switch is in the second triggered state, and the third micro switch is in the third triggered state, the control unit determines that at least one of the micro switches is in a fault state;
in a condition where the first micro switch is in the first triggered state, the second micro switch is in the second triggered state, and the third micro switch is in the third triggered state, the control unit determines that at least one of the micro switches is in a fault state; and
in a condition where the first micro switch is in the first disengaged state, the second micro switch is in the second triggered state, and the third micro switch is in the third disengaged state, the control unit determines that at least one of the micro switches is in a fault state.

4. The solid-state circuit breaker according to claim 3, wherein, in a condition where the control unit detects that the first micro switch is in the first triggered state, the second micro switch is in the second disengaged state, and the third micro switch is in the third disengaged state, the control unit detects the respective states of the micro switches after waiting for a first duration, and wherein, if the respective states of the micro switches do not change after waiting for the first duration, the control unit determines that the mechanical switch or at least one of the micro switches is in a fault state.

5. The solid-state circuit breaker according to claim 3, wherein, in a condition where the control unit detects that the first micro switch is in the first disengaged state, the second micro switch is in the second disengaged state, and the third micro is in the third triggered state, the control unit detects the respective states of the micro switches after waiting for a second duration, and wherein, if the respective states of the micro switches do not change after waiting for the second duration, the control unit determines that the mechanical switch or at least one of the micro switches is in a fault state.

6. The solid-state circuit breaker according to claim 3, wherein after the control unit determines that at least one of the micro switches is in a fault state, or the mechanical switch or at least one of the micro switches is in a fault state, the solid-state circuit breaker enters an electronic open state, and/or the solid-state circuit breaker sends a fault alert message.

7. The solid-state circuit breaker according to claim 2, further comprising a control unit configured to acquire respective states of the micro switches to determine a motion state of the solid-state circuit breaker, the motion state comprising an opening state and a closing state, wherein,
when the first micro switch switches from the first disengaged state to the first triggered state, the control unit determines that the solid-state circuit breaker is in the opening state;
when the second micro switch switches from the second triggered state to the second disengaged state, the control unit determines that the solid-state circuit breaker is in the closing state.

8. The solid-state circuit breaker according to claim 1, wherein the operating component is fixedly provided with a driving portion, the driving portion comprising a first cam portion and a second cam portion fixed relative to each other, and wherein,
the first cam portion is able to press or not press a reed of the first micro switch with a movement of the operating component, to drive the first micro switch to switch between the first triggered state and the first disengaged state;
the second cam portion is able to press or not press a reed of the second micro switch with the movement of the operating component, to drive the second micro switch to switch between the second triggered state and the second disengaged state.

9. The solid-state circuit breaker according to claim 1, wherein the solid-state circuit breaker is configured to open the electronic switch when the first micro switch switches from the first disengaged state to the first triggered state, and to allow a moving contact and a stationary contact of the mechanical switch to separate from each other after opening the electronic switch.

10. The solid-state circuit breaker according to claim 1, wherein the solid-state circuit breaker is configured to detect whether an electrical circuit that the solid-state circuit breaker is connected in is subjected to a reverse voltage with the operating component in the manual open position, and if a reverse voltage is detected in the electrical circuit, to prevent a moving contact and a stationary contact of the mechanical switch from coming into contact with each other when the second micro switch is switched from the second triggered state to the second disengaged state, and if no reverse voltage is detected in the electrical circuit, to allow the moving contact and the stationary contact to come into contact with each other after the second micro switch is switched from the second triggered state to the second disengaged state.
